(19) United States
(12) Patent Application Publication
(10) Pub. No.: US 2024/0234891 A1
(43) Pub. Date: Jul. 11, 2024

(54) MODULE-LESS SUB-PACK DESIGN

(71) Applicants: Pallav JHA, Columbus, IN (US); Cummins Inc., Columbus, IN (US)

(72) Inventors: Pallav Jha, Columbus, IN (US); Daniel Reigels, Ashland, OR (US)

(21) Appl. No.: 18/561,637

(22) PCT Filed: May 31, 2022
(86) PCT No.: PCT/US2022/031606

§ 371 Date: Nov. 16, 2023

Related U.S. Application Data
(60) Provisional application No. 63/194,360, filed on May 28, 2021.

(51) Int. Cl. H01M 50/209; H01M 10/42; H01M 10/6556; H01M 50/227; H01M 50/249; H01M 50/293; H01M 50/51; H01M 50/516

(52) U.S. Cl. CPC H01M 50/209; H01M 10/425; H01M 10/6556; H01M 50/227; H01M 50/249; H01M 50/293; H01M 50/51; H01M 50/516; H01M 2010/4271; H01M 2220/20

(57) ABSTRACT

Disclosed herein are devices, systems, and methods relating to a battery pack. In an example, a battery back can include a bottom cover and a pack housing coupled to the bottom cover. The pack housing can include a plurality of slots for a plurality of individual battery cells. The battery pack can include a thermal plate positioned between the bottom cover and the pack housing. The battery pack can include adhesive disposed in the plurality of slots. The battery pack can include the plurality of individual battery cells disposed respectively in the plurality of slots. The plurality of individual battery cells can be in contact with the adhesive.

### FIELD OF THE DISCLOSURE

The present disclosure relates to battery packs, and more specifically, it relates to battery pack structure.

### BACKGROUND OF THE DISCLOSURE

Certain battery packs, such as for battery-electric or hybrid-electric vehicles, are manufactured by placing multiple battery sub-packs, each with a plurality of modules connected to one another and mounted on a frame within an enclosure.

### SUMMARY

Embodiments of the present disclosure can include a battery pack. The battery pack can include a bottom cover and a pack housing coupled to the bottom cover. The pack housing can include a plurality of slots for a plurality of individual battery cells. The battery pack can include a thermal plate positioned between the bottom cover and the pack housing. The battery pack can include adhesive disposed in the plurality of slots. The battery pack can include the plurality of individual battery cells disposed respectively in the plurality of slots. The plurality of individual battery cells can be in contact with the adhesive. One aspect of this embodiment can include a BMU tray coupled to the pack housing and at least one cross brace. The cross brace can be connected to a first side panel and a second side panel. Another aspect can include an end panel configured to house at least one fitting, a coolant inlet, and a coolant outlet. Yet another aspect can include an encapsulating foam disposed in expansion gaps between adjacent battery cells of the plurality of individual battery cells. Another aspect can include at least one of the BMU tray and the pack housing being formed from a nylon resin. In another aspect of the disclosure, the plurality of individual battery cells can optionally be mechanically bonded to the thermal plate via the adhesive. In still another aspect, the plurality of slots can optionally define a gap between bottom surfaces of the plurality of individual battery cells and an upper surface of the thermal plate. Another aspect can optionally include at least one cross brace being connected to a first side panel and a second side panel mounted to the pack housing.

Embodiments of the present disclosure can include a method of assembling a battery pack. The method can include, providing a bottom cover. The method can further include positioning a thermal plate above the bottom cover. The method can further include positioning a pack housing on the thermal plate. The pack housing can include a plurality of slots. The method can further include dispensing liquid adhesive in the plurality of slots. The method can further include installing a plurality of individual battery cells into the slots. One aspect of this embodiment can include laser welding a plurality of busbars onto the plurality of individual battery cells. Another aspect can include dispensing a liquid solution of encapsulating foam between the plurality of individual battery cells. A further aspect can optionally include positioning a BMU tray on the pack housing and bonding a plurality of BMUs onto the BMU tray. Another aspect can optionally include installing a plurality of cross braces between side panels mounted to the pack housing. Still another aspect can optionally include positioning a compressible foam pad between the bottom cover and the thermal plate and bolting the thermal plate to the bottom cover. Another aspect can optionally include connecting the plurality of individual battery cells in series. The bonding the plurality of BMUs onto the BMU tray can include using electrically insulative adhesive pads.

Embodiments of the present disclosure can include a system having a vehicle and a battery pack. The battery pack can be installed in the vehicle. The battery pack can include a bottom cover and a pack housing coupled to the bottom cover. The pack housing can include a plurality of slots for a plurality of individual battery cells. The battery pack can include a thermal plate positioned between the bottom cover and the pack housing. The battery pack can include adhesive disposed in the plurality of slots. The plurality of individual battery cells can be disposed respectively in the plurality of slots. The plurality of individual battery cells can be in contact with the adhesive and mechanically bonded to the thermal plate via the adhesive. A further aspect can include an encapsulating foam disposed in expansion gaps between adjacent battery cells of the plurality of individual battery cells. A further aspect can include the plurality of slots defining a gap between bottom surfaces of the individual battery cells and an upper surface of the thermal plate. A further aspect can optionally include laser welding a plurality of busbars onto the plurality of individual battery cells.

### BRIEF DESCRIPTION OF THE DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1A is an exploded perspective view of a battery sub-pack according to an embodiment of the present disclosure;

FIG. 1B is a perspective view of the battery sub-pack of FIG. 1A in an intermediate stage of assembly;

FIG. 1C is a perspective view of the battery sub-pack of FIG. 1A in an intermediate stage of assembly;

FIG. 1D is a perspective view of the battery sub-pack of FIG. 1A in an intermediate stage of assembly;

FIG. 1E is a perspective view of the battery sub-pack of FIG. 1A in an intermediate stage of assembly;

FIG. 1F is a perspective view of the battery sub-pack of FIG. 1A in an intermediate stage of assembly;

FIG. 1G is a perspective view of the battery sub-pack of FIG. 1A in an intermediate stage of assembly;

FIG. 1H is an exploded perspective view of a BMU tray and a pack housing of the battery sub-pack of FIG. 1A;

FIG. 1I is a perspective view of the battery sub-pack of FIG. 1A in an intermediate stage of assembly;

FIG. 1J is a perspective view of the battery sub-pack of FIG. 1A in an intermediate stage of assembly;

FIG. 2 is a sectioned perspective view of a partially assembled battery sub-pack according to an embodiment of the present disclosure;

FIG. 3 is a perspective view of a fully assembled battery sub-pack according to an embodiment of the present disclosure;

FIG. 4 is a sectioned perspective view of a partially assembled battery sub-pack according to an embodiment of the present disclosure;

FIG. 5 is a top plan view of adjacent cells mounted in a battery sub-pack according to an embodiment of the present disclosure;

FIG. 6 is a flow chart of an assembly process for assembling a battery sub-pack according to an embodiment of the present disclosure;

FIG. 7 is a perspective view of a vehicle having at least one battery sub-pack installed according to an embodiment of the present disclosure.

### DETAILED DESCRIPTION

Certain battery packs such as for battery-electric or hybrid-electric vehicles are manufactured by placing multiple battery sub-packs, each with a plurality of modules connected to one another and mounted on a frame within an enclosure. Weight of the battery pack is a key concern for vehicle applications. Conventional battery packs have relatively low gravimetric energy density (i.e., energy per unit weight such as kWh/kg), in part due to the structural elements inside all of the sub-pack modules, which add weight. Additionally, conventional battery packs have relatively low volumetric efficiency, which is a measure of energy provided per unit volume. Embodiments of the present disclosure, discussed below, address these and other challenges.

For the purposes of promoting an understanding of the principles of the disclosure, reference will now be made to the embodiments illustrated in the drawings, which are described below. The embodiments disclosed below are not intended to be exhaustive or limit the disclosure to the precise form disclosed in the following detailed description.

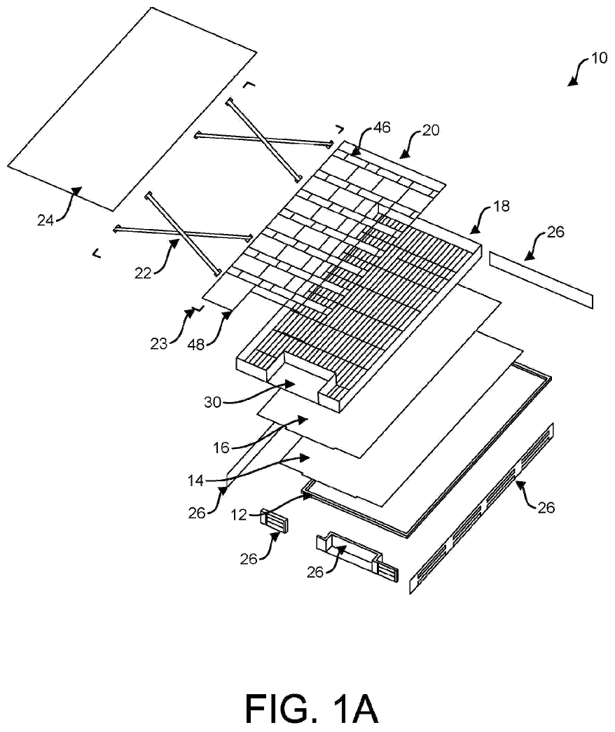

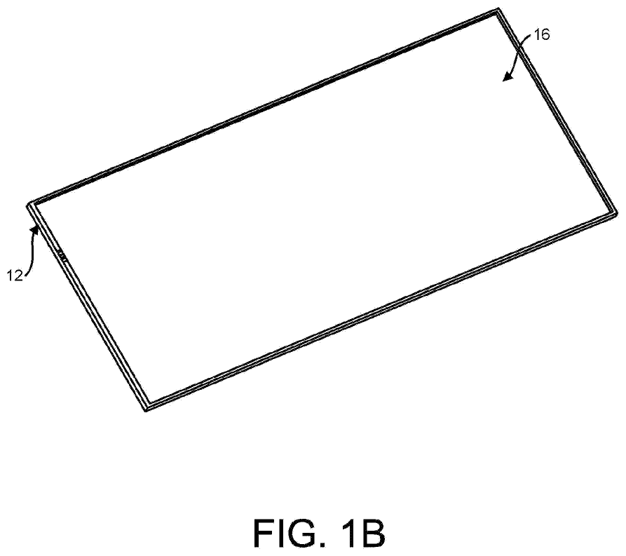

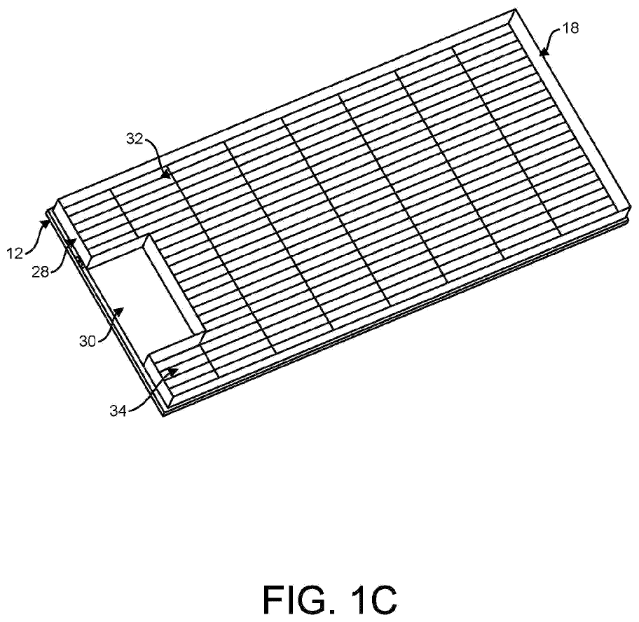

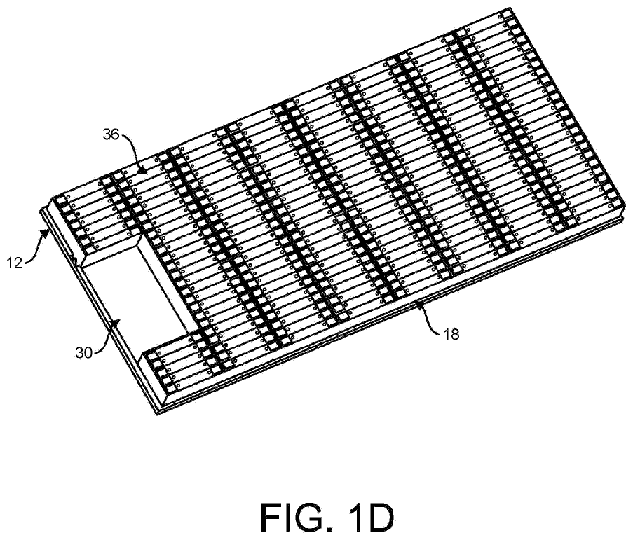

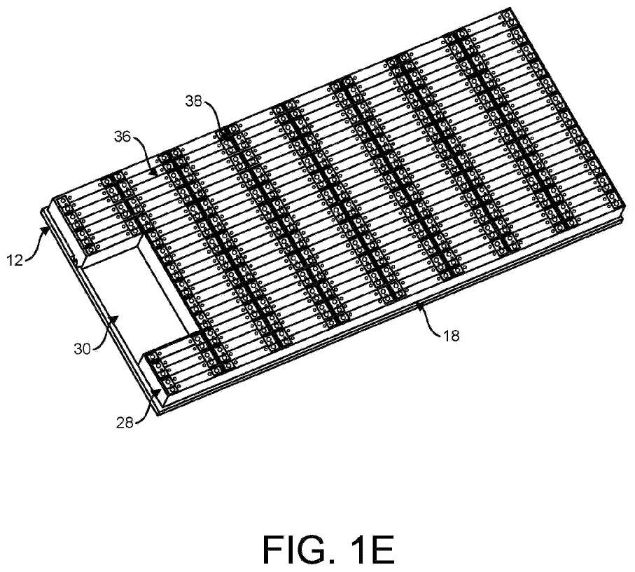

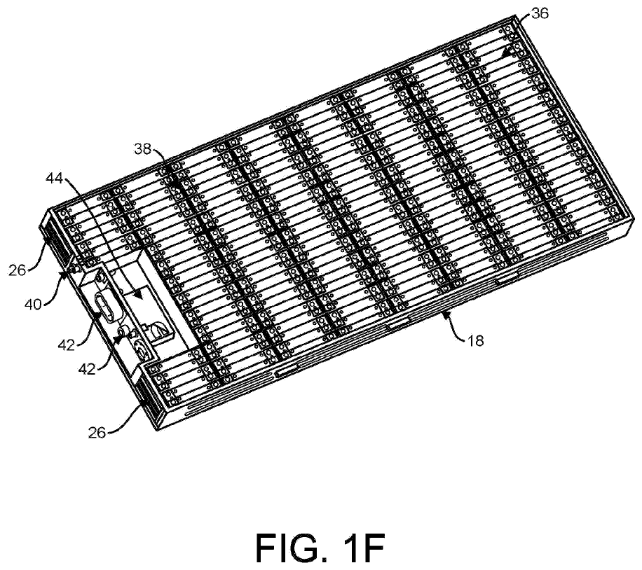

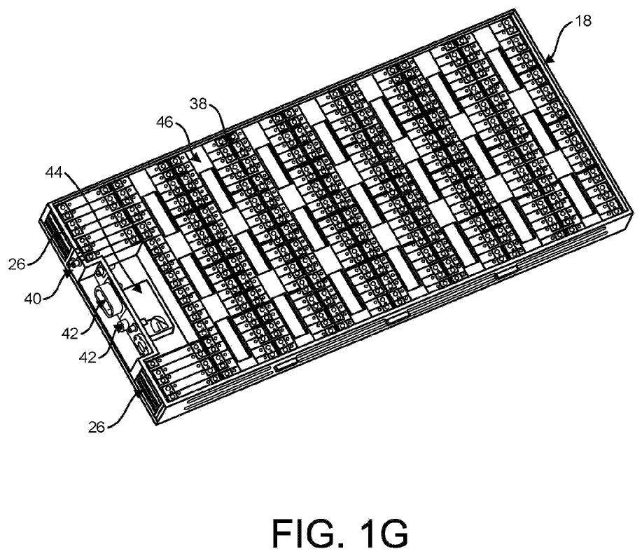

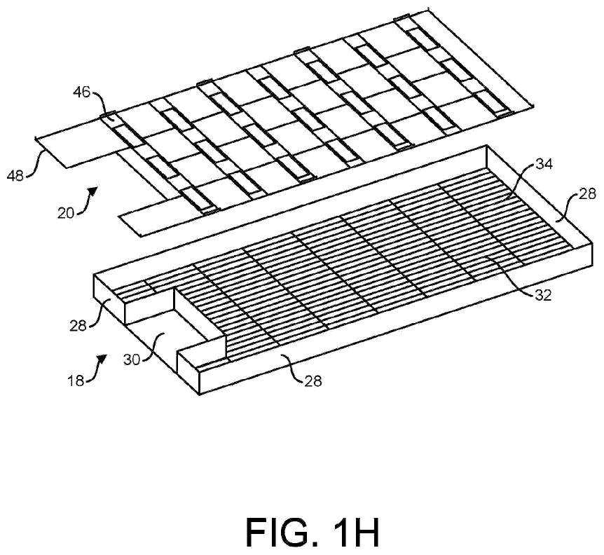

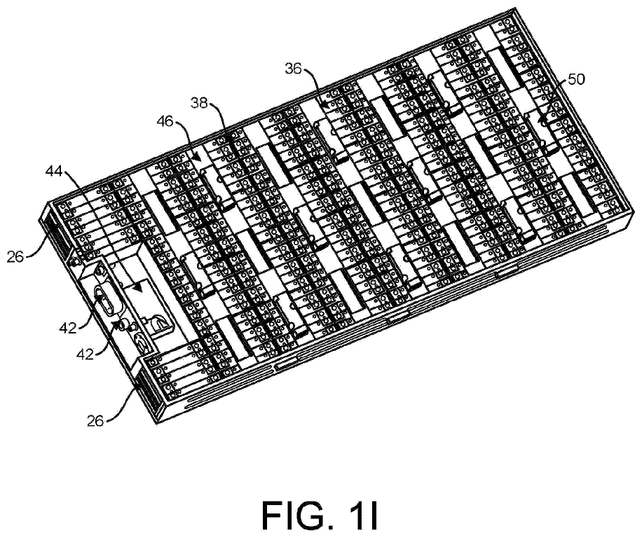

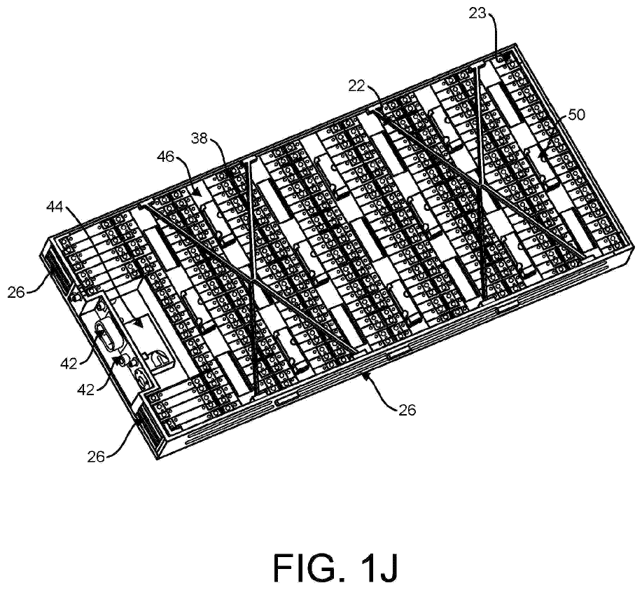

FIG. 1A is an exploded view of an embodiment of a battery sub-pack 10 according to one embodiment of the present disclosure. It should be understood that multiple sub-packs 10 may be used together to form a battery assembly. Battery sub-pack 10 generally includes a bottom cover 12, a foam layer 14, a thermal plate or cold plate 16, a pack housing 18, a battery management unit (BMU) tray 20, a plurality of braces 22, a top cover 24 and a plurality of side panels 26. Various other components such as fasteners, connectors, etc. are not show in FIG. 1A for simplicity.

Battery pack 10 is assembled onto bottom cover 12 in the manner described below. Specifically, foam layer 14 is first installed onto bottom cover 12. Foam layer 14 may be a 3 mm thick foam pad in one embodiment of the disclosure. In one example construction, foam layer 14 is compressed to a thickness of approximately 0.5 mm upon installation of cold plate 16 as described below.

FIG. 1B shows cold plate 16 mounted onto foam layer 14 and bottom cover 12. In one embodiment, cold plate 16 is bolted to bottom cover 12 (through foam layer 14), thereby compressing foam layer 14. As shown in FIG. 1C, pack housing 18 is installed onto cold plate 16 to form a receptacle for individual cells as is described herein. Pack housing 18 includes side walls 28, a pack management unit (PMU) mount 30 and a plurality of wires 32 extending between side walls 28 to form a plurality of slots 34 configured to receive individual battery cells 36. In one embodiment of the disclosure, a liquid adhesive (not shown) is dispensed into slots 34 to provide mechanical bonding of the cells 36 to the cold plate 16, which may be formed from aluminum, and add structural rigidity to the assembly.

In some embodiments, the liquid adhesive may include a material having relatively high thermally conductive and good electrically insulative properties. For example, in some instances, the liquid adhesive may have a thermal conductivity between approximately 1.5 to 3 W/(m-K) (watts per meter-kelvin). In some instances, the liquid adhesive may have a dielectric strength greater than 6 kV/mm (kilovolts per millimeter). In some embodiments, the liquid adhesive may have properties such as a relatively low density such as for example less than 0.75 kg/L (kilograms per liter); a relatively low viscosity such as for example less than 50,000 cP (centipoise); and/or a shear strength sufficient for the application, such as for example greater than 10 MPa (megapascal). In some embodiments, the liquid adhesive may bond to metals and low surface energy plastics at levels at least sufficient for the application. In some embodiments, the liquid adhesive may be a flame retardant material and/or have a relatively fast curing time such as for example less than or much less than 1 hour. In some instances, the liquid adhesive can be selected the group including commercially available EV PROTECT 4006 from HB Fuller, SYLGARD 170, DOWSIL 3-3186, and DOWSIL 3-6548 from Dow, COOLTHERM SC305/303/315/252/320/324, and UR-2000 from Lord, and TC-2707 from 3M. Such adhesives may facilitate efficient heat transfer and manufacturing and contribute to the volumetric and gravimetric efficiency of the battery sub-pack.

As best shown in FIG. 1D, a plurality of cells 36 is next installed into pack housing 18, with each cell 36 being installed into a corresponding slot 34. In one embodiment, the adhesive in slots 34 is allowed to cure at room temperature. As shown in FIG. 1E, a plurality of busbars 38 are placed onto cells 36 using an automatic placement system. Busbars 38 are then laser welded to cells 36 to make the electrical connection between the cells. In one embodiment, 180 cells 36 are included in each sub-pack 10 connected in series to provide approximately 100 kWh power. In one embodiment of the disclosure, a liquid solution of encapsulating foam is dispensed between cells 36 and allowed to cure at room temperature. Such encapsulating foam may provide heat transfer from cells 36 to cold plate 16. As is known in the art, coolant is directed through cold plate 16 to remove heat.

Referring now to FIG. 1F, battery pack 10 is shown with side panels 26 mounted to pack housing 18. Additionally, coolant fittings 40, electrical connectors 42 and a PMU 44 are shown installed in PMU mount 30. Next, as shown in FIG. 1G, BMU tray 20 is shown mounted to pack housing 18. As shown in FIG. 1A and FIG. 1G, BMU tray 20 includes a plurality of BMU mounting surfaces 46 connected mechanically together by support rods 48. BMU tray 20 restricts motion of cells 36 in the vertical direction to secure cells 36 in place.

FIG. 1H is an exploded view of BMU tray 20 and pack housing 18. At least one of BMU tray 20 and pack housing 18 may be formed from a nylon resin. For example, BMU tray 20 may be made from a nylon resin and pack housing 18 may be made from another material or vice versa. Also, both BMU tray 20 and pack housing 18 may be formed by a nylon resin. For example, Nylon 66 GF-35 or another similar material for additional stiffness compared to traditional plastic may be used. The slots 34 in pack housing 18 define a gap 52 between the bottom surfaces of the individual battery cells 36 and an upper surface of cold plate 16.

After BMU tray 20 is installed, a plurality of BMUs 50 is mounted onto BMU tray 20 as shown in FIG. 1I. In one embodiment, ten BMUs 50 are installed, each BMU 50 managing 18 individual cells 36. In one embodiment, BMUs 50 are bonded to BMU tray using electrically insulative adhesive pads (not shown).

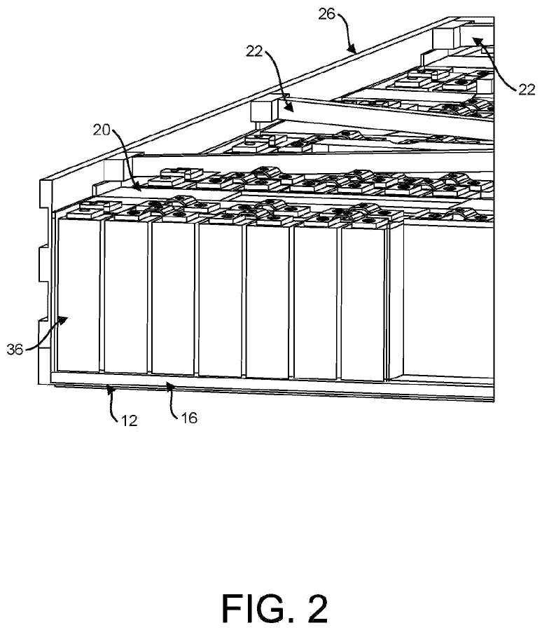

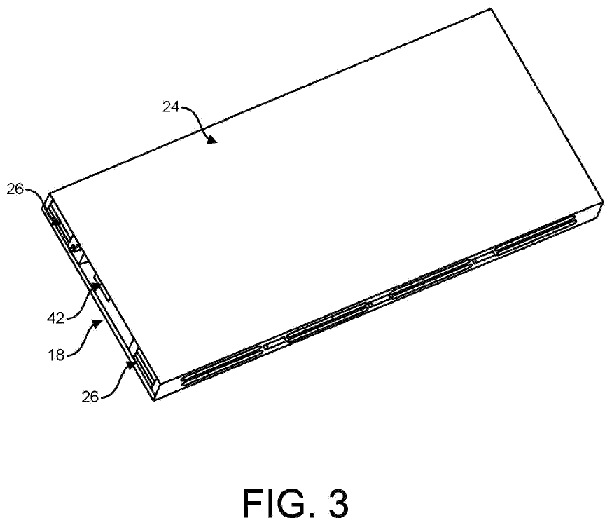

FIG. 1J shows four corner braces 23 installed at the corners of side panels and internal braces 22 bolted between side panels 26. FIG. 2 provides a sectioned, perspective view. Internal braces 22 add structural rigidity to battery pack 10 and restrict vertical movement of BMU tray 20, and therefore vertical movement of cells 36. It should be understood that more or fewer internal braces 22 may be used in various embodiments, and the location of the braces 22 may vary. Finally, as shown in FIG. 3, top cover 24 is attached to pack housing 18.

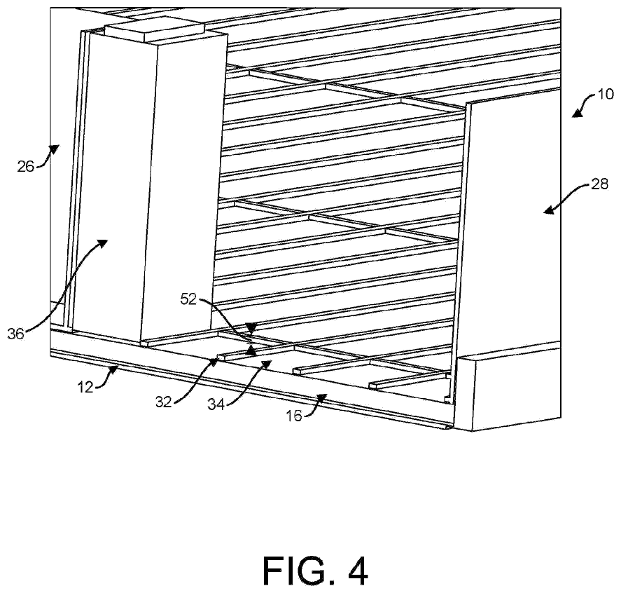

FIG. 4 is a sectional view of an embodiment of a battery sub-pack 10. As indicated above, the plurality of cells 36 are mechanically bonded to cold plate 16 via adhesive. In some embodiments, slots 34 define a gap 52 between the bottom surfaces of cells 36 and an upper surface of cold plate 16. In some embodiments the maximum distance of gap 52 is 1 mm.

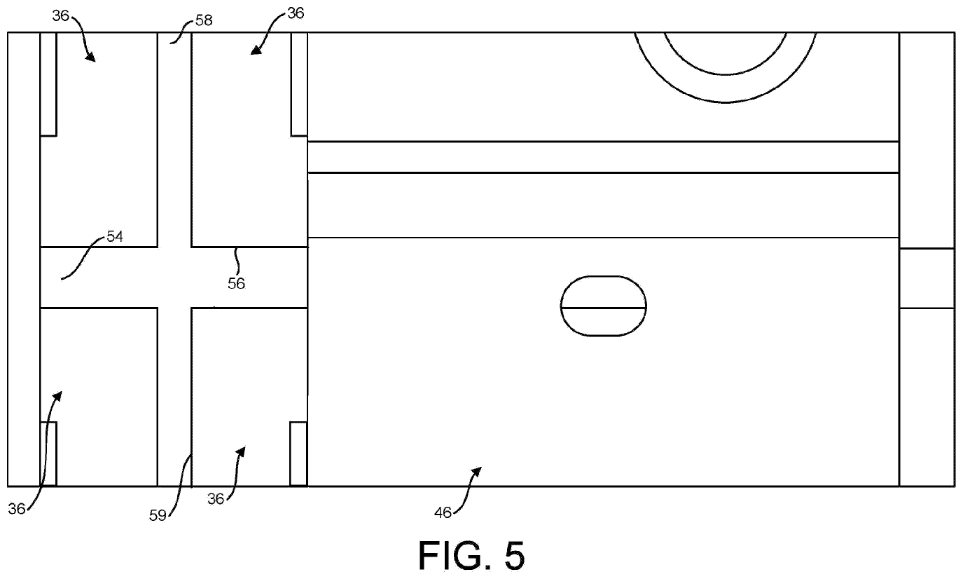

Referring now to FIG. 5, a close-up view of cells 36 is shown. As indicated, a gap 54 is provided between cells 36 along the short edges 56 of cells 36 and a gap 58 is provided along the long edges 59 of cells 36. In one embodiment, gap 54 is approximately 3.5 mm and gap 58 is approximately 2.0 mm. These gaps 54, 58 accommodate thermal expansion of cells 36. In one embodiment, the gaps 54, 58 are configured to accommodate a maximum dimensional expansion of cells 36 of 10% and a maximum compression of foam layer 14 of 90%.

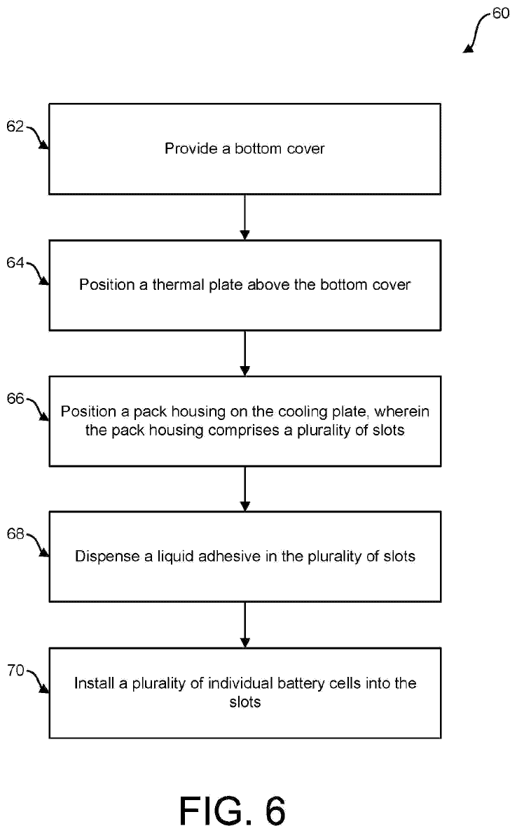

FIG. 6 is a method 60 for assembling a battery sub-pack 10. First, a bottom cover 12 is provided at step 62. A cold plate 16 is then positioned above bottom cover 12 at step 64. A pack housing 18, which has a plurality of slots 34, is then positioned on cold plate 16 at step 66. Liquid adhesive is then dispensed into slots 34 at step 68. After the liquid adhesive has been dispensed, a plurality of cells 36 are inserted into slots 34 of pack housing 18 at step 70. A liquid solution of encapsulating foam can be dispensed between battery cells 36 in some embodiments.

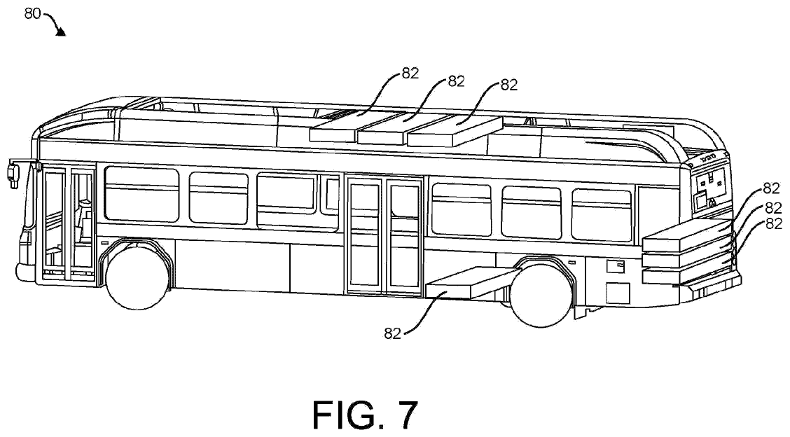

FIG. 7 shows a vehicle 80 having one or more battery sub-packs 82 installed. Vehicle 80 may be a battery-electric or hybrid-electric vehicle. Each of the battery sub-packs 82 may be identical or substantially similar to battery sub-pack 10 discussed with respect to FIGS. 1A-6.

It should be understood that any prismatic cell of any dimension may be used with variants of the present disclosure. The design and assembly of a sub-pack according to embodiments of the present disclosure may result in a reduced manufacturing cost of the sub-pack. Additionally, embodiments of the present disclosure may increase volumetric and gravimetric efficiency of a battery sub-pack by incorporating a reduced quantity of structural elements, such as fastening/joining hardware.

The scope of the disclosure is to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Furthermore, no element, component, or method step in the present disclosure is intended to be dedicated to the public regardless of whether the element, component, or method step is explicitly recited in the claims. No claim element herein is to be construed under the provisions of 35 U.S.C. § 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A battery pack, comprising:
a bottom cover;
a pack housing coupled to the bottom cover, the pack housing having a plurality of slots for a plurality of individual battery cells;
a thermal plate positioned between the bottom cover and the pack housing;
adhesive disposed in the plurality of slots; and
the plurality of individual battery cells disposed respectively in the plurality of slots, the plurality of individual battery cells in contact with the adhesive.

2. The battery pack of claim 1, further comprising a BMU tray coupled to the pack housing and at least one cross brace, wherein the at least one cross brace is connected to a first side panel and a second side panel.

3. The battery pack of claim 1, further comprising an end panel configured to house at least one fitting, a coolant inlet, and a coolant outlet.

4. The battery pack of claim 1, further comprising an encapsulating foam disposed in expansion gaps between adjacent battery cells of the plurality of individual battery cells.

5. The battery pack of claim 2, wherein at least one of the BMU tray and the pack housing is formed from a nylon resin.

6. The battery pack of claim 1, wherein the plurality of individual battery cells are mechanically bonded to the thermal plate via the adhesive.

7. The battery pack of claim 1, wherein the plurality of slots defines a gap between bottom surfaces of the plurality of individual battery cells and an upper surface of the thermal plate.

8. The battery pack of claim 1, further comprising at least one cross brace connected to a first side panel and a second side panel mounted to the pack housing.

9. A method of assembling a battery pack, comprising:
providing a bottom cover;
positioning a thermal plate above the bottom cover;
positioning a pack housing on the thermal plate, wherein the pack housing comprises a plurality of slots;
dispensing liquid adhesive in the plurality of slots; and
installing, respectively, a plurality of individual battery cells into the plurality of slots.

10. The method of claim 9, further comprising laser welding a plurality of busbars onto the plurality of individual battery cells.

11. The method of claim 9, further comprising dispensing a liquid solution of encapsulating foam between the plurality of individual battery cells.

12. The method of claim 9, further comprising positioning a BMU tray on the pack housing and bonding a plurality of BMUs onto the BMU tray.

13. The method of claim 9, further comprising installing a plurality of cross braces between side panels mounted to the pack housing.

14. The method of claim 9, further comprising positioning a compressible foam pad between the bottom cover and the thermal plate and bolting the thermal plate to the bottom cover.

15. The method of claim 9, further comprising connecting the plurality of individual battery cells in series.

16. The method of claim 12, wherein the bonding the plurality of BMUs onto the BMU tray includes using electrically insulative adhesive pads.

17. A system comprising:
a vehicle;
a battery pack installed in the vehicle, the battery pack comprising:
a bottom cover;
a pack housing coupled to the bottom cover, the pack housing having a plurality of slots for a plurality of individual battery cells;
a thermal plate positioned between the bottom cover and the pack housing;
adhesive disposed in the plurality of slots; and
the plurality of individual battery cells disposed respectively in the plurality of slots, the plurality of individual battery cells in contact with the adhesive and mechanically bonded to the thermal plate via the adhesive.

18. The system of claim 17, further comprising an encapsulating foam disposed in expansion gaps between adjacent battery cells of the plurality of individual battery cells.

19. The system of claim 17, wherein the plurality of slots defines a gap between bottom surfaces of the plurality of individual battery cells and an upper surface of the thermal plate.

20. The system of claim 17, further comprising a plurality of busbars laser welded onto the plurality of individual battery cells.
